(19) United States
(12) Patent Application Publication
(10) Pub. No.: US 2006/0162841 A1
(43) Pub. Date: Jul. 27, 2006

(54) Apparatus and method for controlling roller rotation of laminator

(75) Inventor: Dong-Won Hong, Incheon-si (KR)

Correspondence Address: SALIWANCHIK LLOYD & SALIWANCHIK;A PROFESSIONAL ASSOCIATION, PO BOX 142950, GAINESVILLE, FL, 32614-2950, US

(73) Assignee: Royal Sovereign, Inc, Incheon-si (KR)

(21) Appl. No.: 10/515,096

(22) PCT Filed: May 12, 2003
(86) PCT No.: PCT/KR03/00932

§ 371 Date: Jun. 2, 2005

(30) Foreign Application Priority Data
May 21, 2002 (KR) 20-2002-0015434

(51) Int. Cl. B32B 37/00; B29C 63/02; B32B 38/00

(52) U.S. Cl. 156/64; 156/359; 156/350; 156/362; 156/368; 156/583.1

(57) ABSTRACT

There exist many problems that the film is wound on the heating roller or the pressing roller during operation of the laminator. Disclosed is an apparatus and method for controlling roller rotation in the laminator in order to resolve such problems, such that the film detecting sensor in the entrance side and the film detecting sensor in the exit side are provided in the front and back of the roller for normal operation of the laminator, so that if the film is not detected by the film detecting senor in the exit side after insertion of the laminating film is detected by the film detecting sensor in the entrance side, then the roller is rotated backward under judgment that the laminator does not normally operate.

### TECHNICAL FIELD

The present invention relates to a laminator and more particularly to an apparatus and method for controlling roller rotation of a laminator, capable of automatically removing a film upon abnormal operation of the laminator when the laminating film is wound on a roller, or film jam is generated in the inside of the laminator.

### BACKGROUND ART

A laminator is an apparatus used for coating both sides of a plate shaped product using a film in order to improve durability of the plate shaped product such as a paper and a panel.

Generally, a laminator includes, as primary elements, a heating roller for applying heat on a laminating film upon coating; a pressing roller for making the films on both sides stuck on the product by applying pressure on the heated laminating film; and a motor for applying rotational force on the heating roller and the pressing roller.

Operation of the laminator will be described. After a film is inserted into the laminator, heat is applied to the laminating film by the heating roller. The film on which heat is applied, changes into a flexible status where sticking is possibly performed, and pressure is applied on that flexible film by the pressure roller, so that a pair of the laminating films is stuck on each other. At the moment, an adhesive could be provided on a contact surface of the film so that adhesive property may be improved.

But, in case that the temperature appropriate for thickness of the laminating film is not properly adjusted or a small size laminating film is used in such laminator, the heated laminating film is wound on the heating roller or the pressing roller and operation of the laminator is not normally performed.

Also, in case that the film is not inserted in a correct angle but in a twisted angle when inserted into the laminator, a jam of the film is generated in the inside of the laminator and operation of the laminator is not normally performed from time to time.

A method of a related art used for removing the laminating film from the inside of the laminator in such cases, will be described in the following.

Firstly, a method for forcibly removing the film after stopping and disassembling the laminator.

Secondly, a method for removing the film such that a dual-direction rotating motor is installed so that a user may manually adjust rotational direction of the motor in order to rotate backward the heating roller and the pressing roller in the inside of the laminator when the film is wound in the inside of the laminator.

Thirdly, a method suggested in the Korean Utility Model Registration No. 263043, in which a predetermined device for detecting thickness of the film piled up is installed on the outer periphery of the roller, so that the motor is automatically rotated backward for the film to be removed if the film is wound on the roller and reaches up to a predetermined thickness.

According to the above first method, visiting of an expert is required to disassemble the laminator and the laminator should be assembled again after the laminator is disassembled and the film is removed.

According to the second method, a user should continuously observe whether the film is normally inserted in or drawn out and should directly adjust operation of the laminator. Also, in case that much time lapses and the laminating film is deeply wound in the inside of the laminator while a user does not observe the laminator upon coating job, the laminator machine itself including the roller might be destroyed.

According to the third method, winding of the film on the roller could be detected if and only if the film is continuously wound on the roller and reaches up to a considerable thickness. Therefore, abnormal operation of the laminator could not be detected until malfunction already occurs for a considerable period of time. Also, a predetermined device for detecting the thickness of the piled up film should be installed on all the rollers where there exist possibility that malfunction occurs, so that this method could not be applied to the laminator on which the rollers are formed in multi-levels. Also, due to inaccuracy of mechanical detection of the film thickness, reliability could not be secured in detecting malfunction of the laminator.

### DISCLOSURE OF INVENTION

To solve the above-indicated problems, it is, therefore, an object of the present invention to provide an apparatus and method for controlling roller rotation of a laminator, which is convenient and reliable.

An apparatus for controlling roller rotation of a laminator according to the present invention, includes: rollers installed in even numbers, for applying heat and pressure in order to perform coating using a laminating film; a film detecting sensor in an entrance side, formed in the front side of the roller with respect to the progressing direction of the laminating film, for detecting whether the laminating film is inserted or not; a film detecting sensor in an exit side, formed in the rear side of the roller, for detecting whether the laminating film is drawn out or not; a dual-direction rotating motor for rotating the roller forward or backward depending on a detecting signal from the film detecting sensors in the entrance side and the exit side; a microprocessor for receiving a detecting signal from the sensor and transmitting a controlling signal to the dual-direction rotating motor; and a power transferring unit for transferring power from the dual-direction motor to the roller.

A method for controlling roller rotation of a laminator according to the present invention, includes the steps of: counting time from the moment that insertion of a laminating film is detected by a film detecting sensor in an entrance side after the laminating film is inserted into the laminator; detecting, at a film detecting sensor in an exit side, the laminating film after waiting time T1 that is necessary for normal laminating operation lapses; judging that normal laminating is performed if the laminating film is detected before the waiting time T1 lapses, and removing the film by rotating backward the roller for a predetermined period of time T2 under the judgment that normal laminating is not performed if the laminating film is not detected even after the waiting time T1 lapses.

### BRIEF DESCRIPTION OF INVENTION

The above objects, features and advantages of the present invention will become more apparent from the following detailed description when taken in conjunction with the accompanying drawings, in which:

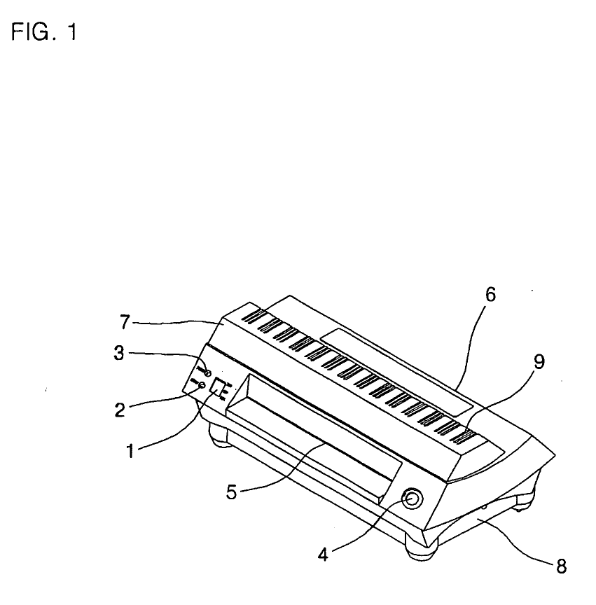

FIG. 1 is a perspective view of an appearance of a laminator adopting an apparatus for controlling roller rotation of a laminator according to the present invention;

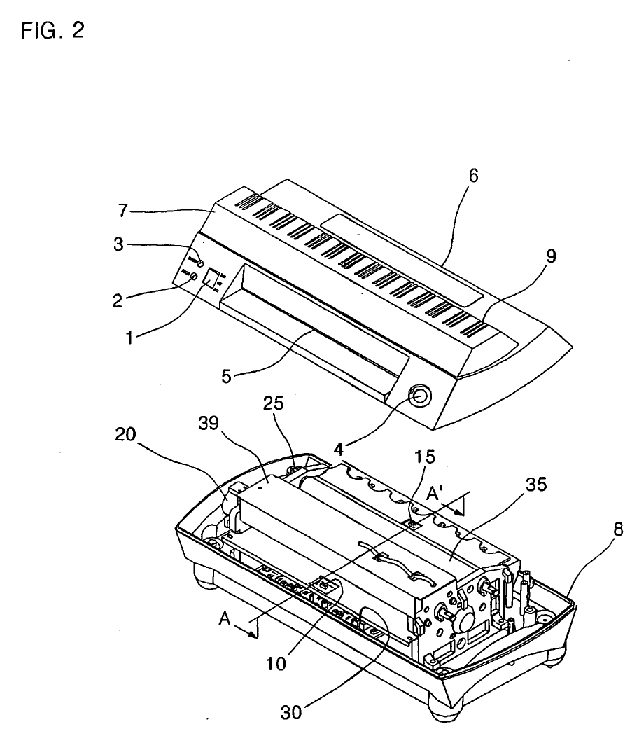

FIG. 2 is a perspective view of a laminator whose upper cover is separated in a laminator adopting an apparatus for controlling roller rotation according to the present invention;

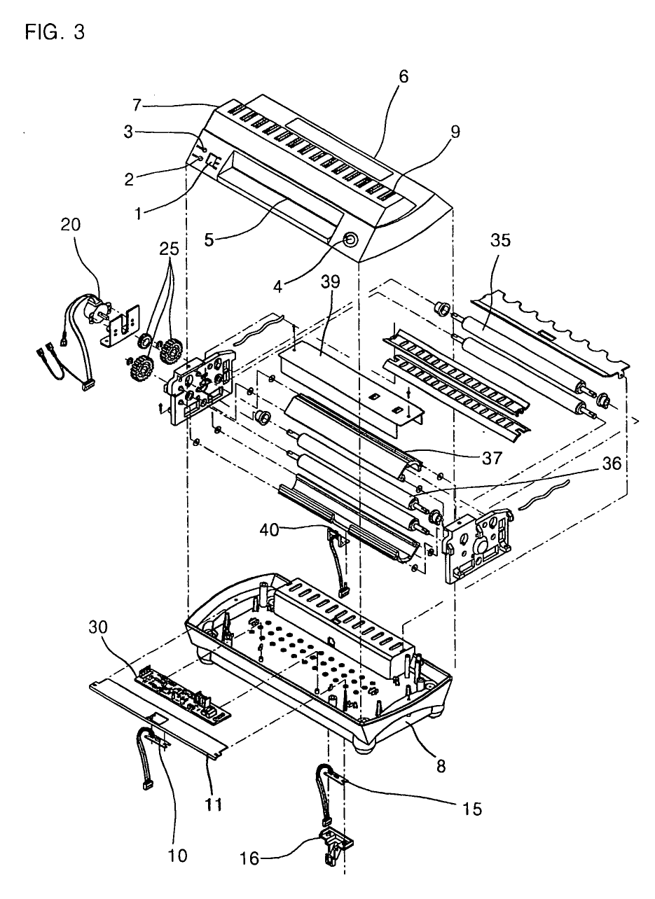

FIG. 3 is an exploded, perspective view of a crucial part of a laminator adopting an apparatus for controlling roller rotation according to the present invention;

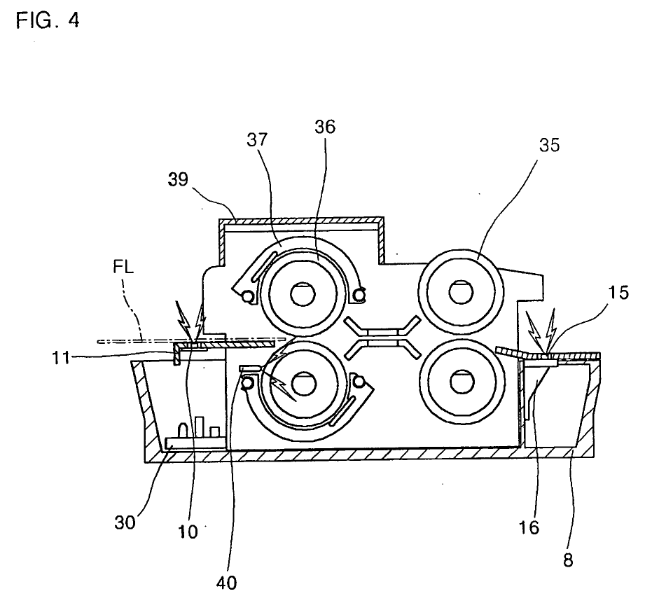

FIG. 4 is a schematic, cross-sectional view taken along line A-A′ in FIG. 2, illustrating operation of an apparatus for controlling roller rotation of a laminator according to the present invention; and

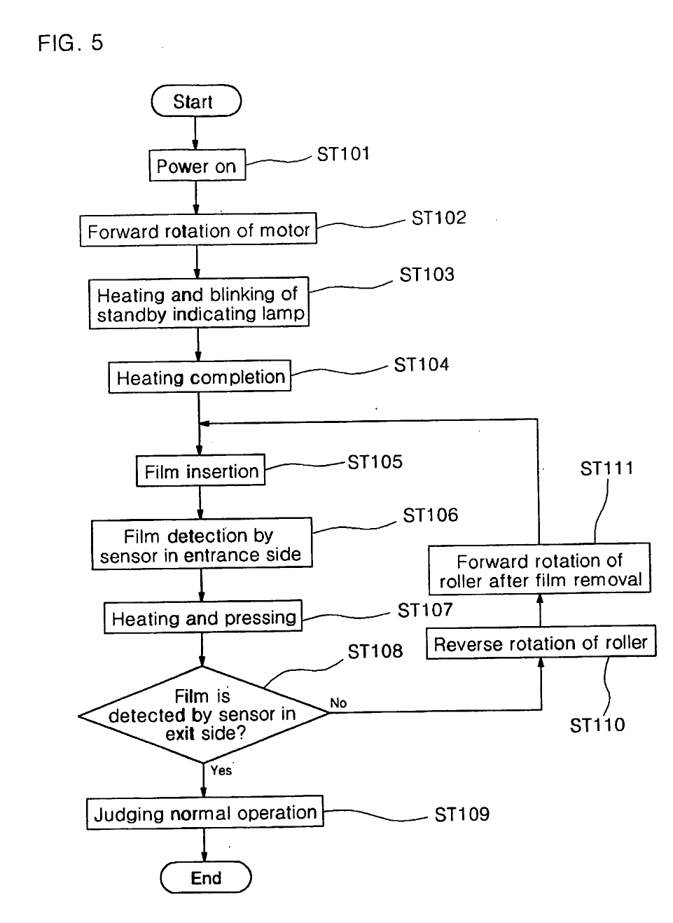

FIG. 5 is a flowchart illustrating a method for controlling roller rotation of a laminator according to the present invention.

### BEST MODE FOR CARRYING OUT THE INVENTION

A preferred embodiment of the present invention will now be described with reference to the accompanying drawings. The matters defined in the description such as a detailed construction and elements are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

FIG. 1 is a perspective view of an appearance of a laminator adopting an apparatus for controlling roller rotation of a laminator according to the present invention.

Referring to FIG. 1, an appearance of the present invention includes an upper cover 7 and a lower cover 8 forming an appearance of the laminator, and the upper cover 7 includes: a power switch 1 for controlling on/off of the laminator, a standby indicating lamp 2 for indicating an operation standby status of a laminator; a power indicating lamp 3 for indicating a status that power of the laminator is turned on; a temperature adjusting member 4 for properly adjusting temperature depending on thickness of a laminating film; and a receiving member 5 formed lengthwise in the front side, for receiving the laminating film.

Also, a drawing member 6 through which a coated laminating film is drawn out is provided in the rear side of the upper cover 7, and a plurality of heat emitting members 9 for emitting heat from the inside of the laminator, is provided on the front side of the upper cover 7.

Mores specifically, for the power switch 1, a switching means of three steps for controlling status of forward rotation, backward rotation, and off status of the laminator, is used. With such construction, forward and backward rotations of the laminator could be controlled by direct operation of a user.

Also, the heat emitting member 9 has a plurality of slits in a long hole shape, so that heat generated from the inside of the laminator may be swiftly emitted to the outside.

Also, for the temperature adjusting member 4, a rotary switch turned directly by a user is used, so that appropriate temperature may be adjusted.

Referring to FIG. 1, operation of the laminator according to the present invention will be briefly described. In case that a user intends to operate the laminator, the power switch 1 is set to on-status where the roller is rotated forward, so that the roller may be rotated. Then, temperature of the temperature adjusting member 4 is appropriately selected depending on thickness of the laminating film, so that the heating roller in the inside of the laminator may be heated to an appropriate temperature. At the moment, the standby indicating lamp 2 keeps blinking until the heating roller reaches a temperature range appropriate for performance of laminating while the heating roller is heated, so that a user may recognize the standby status of the laminator, namely, the status that the laminator is not yet prepared for laminating operation.

If the heating roller reaches an appropriate temperature, the standby lamp 2 stops blinking and maintains lighted-up status, so that a user may recognize that the heating roller is prepared for laminating operation and perform laminating job.

In the meantime, in case that a user recognizes that the film is caught in the inside of the laminator, or the film is wound on the roller, a user could make the film drawn out through the receiving member 5 by directly controlling the power switch 1 in order to get the roller to be rotated backward.

Rest part not described in the foregoing will be described in more detail in the following.

FIG. 2 is a perspective view of a laminator whose upper cover is separated in a laminator adopting an apparatus for controlling roller rotation according to the present invention.

Referring to FIG. 2, the laminator of the present invention includes: a controlling substrate 30 in which a temperature adjusting member 4, a power switch 1, a standby indicating lamp 2, a power indicating lamp 3 are connected by a predetermined wiring so that a series of operation by the laminator may be performed; a heating roller (not shown) formed up and down in pairs, for applying heat on the laminating film; a pressing roller 35 formed in the rear side of the heating roller, for pressing the laminating film; a dual-direction rotating motor 20 for applying rotational force on the heating roller 36 and the pressing roller 35; a power transferring unit 25 for transferring power of the dual-direction rotating motor 20 to the heating roller 36 and the pressing roller 35. Also, a heating cover 39 for safe performance of job is additionally provided on the outer side of the heating roller.

More specifically, the power transferring unit 25 has a plurality of gears for transferring torque of the dual-direction rotating motor 20. But, construction for power transfer is not necessarily limited to gears and a person skilled in the art would easily think of various power transferring mechanism such as a belt, a sprocket.

Particularly, a film detecting sensor 10 in an entrance side, for detecting insertion status of the laminating film to be inserted, is provided in the front of the heating roller, and a film detecting sensor 15 in an exit side, through which the laminating completed film is drawn out, is provided in the rear side of the pressing roller 35.

Also, for the film detecting sensor 10 in the entrance side and the film detecting sensor 15 in the exit side, a member for simultaneously emitting and receiving light is used, so that existence of the film is detected and insertion and drawing out of the film are detected if light emitted from a light emitting unit of the sensor is reflected from the film and received to a light receiving unit of the sensor. Here, for the light used for the sensors 10 and 15, an ultraviolet ray is used for stable operation of the machine.

Also, a microprocessor is mounted on the controlling substrate 30, for controlling the operation of the laminator on the whole. A plurality of entering lines connected to parts such as the sensors 10 and 15, the power switch 1, is connected to the controlling substrate 30 so that operation of the laminator may be stably performed.

FIG. 3 is an exploded, perspective view of a crucial part of a laminator adopting an apparatus for controlling roller rotation according to the present invention.

Referring to FIG. 3, a heat applying unit 37 for applying heat on the heating roller 36, and the heating cover 39 formed on the upper side of the heat applying unit 37, for stable operation of the machine, are provided on the outer side of the heating roller 36.

The film detecting sensor 10 in the entrance side is fixed by a sensor fixing panel 11, and the sensor fixing panel 11 is settled down in its both ends on the boss formed on the inner lower, side of the lower cover 8. At the moment, the light emitting unit and the light receiving unit of the film detecting sensor 10 in the entrance side are put on a hole formed on the central portion of the sensor fixing panel 11, so that projection and incidence of light may not be disturbed.

But, for the film detecting sensor 10 in the entrance side, any member whatsoever may be used as far as the member is formed in front of the heating roller 36, namely, the first roller, and detailed construction and method in installing the member are not limited to those shown in the drawing.

Also, the film detecting sensor 15 in the exit side is provided in the rear side of the pressing roller 36, in order to detect whether the coated film is normally drawn out or not. Also, the film detecting sensor 15 in the exit side is fixed by a sensor fixing unit 16 formed on the back of the lower cover 8. But, for the film detecting sensor 15 in the exit side, any member whatsoever may be used as far as the member is formed in the rear side of the pressing roller 35, namely, the final roller, and detailed construction and method in installing the member are not limited to the sensor fixing unit 16 shown in the drawing.

In the meantime, on the position adjacent to the heating roller 36, specifically on one side of the heat applying unit 37, a temperature sensor 40 for detecting the temperature of the heating roller 36 is formed, so that the appropriate temperature of the heating roller 36 may be known and coating of the laminating film may be swiftly performed depending on the thickness.

More specifically, if a user designates an appropriate temperature for the laminating film using the temperature adjusting member (refer to reference numeral 4 in FIG. 1), the temperature sensor 40 detects the temperature of the heating roller 36, transferring the same to the controlling substrate 30 so that the heating roller 36 may be heated to the designated temperature. The microprocessor of the controlling substrate 30 controls the power of the heat applying unit 37 and the standby indicating lamp 2 depending on the temperature of the temperature sensor 40, thereby controlling application of the power to the heat applying unit 37 and the lighting of the standby indicating lamp 2.

FIG. 4 is a schematic, cross-sectional view taken along line A-A′ in FIG. 2, illustrating operation of an apparatus for controlling roller rotation of a laminator according to the present invention.

Referring to FIG. 4, an apparatus and method for controlling roller rotation of a laminator according to the present invention will be described in the following.

If the laminating film FL is inserted into the inside of the laminator by a user after the temperature of the heating roller 36 reaches an appropriate temperature, the laminating film is detected by the film detecting sensor 10 in the entrance side. At the moment, a detecting signal from the film detecting sensor 10 in the entrance side due to insertion of the film, is transferred to the microprocessor formed in the controlling substrate 30, so that time from the moment that insertion of the film is detected, is counted.

Then, when the film is drawn out after laminating is performed by the heating roller 36 and the pressing roller 35, the film detecting sensor 15 in the exit side detects whether the film is drawn out or not, so that normal performance of coating for laminating film could be checked.

But, in case that coating is not normally performed, the film is not drawn out to the drawing member (refer to reference numeral 6 in FIG. 1).

In that case, the film is not detected by the film detecting sensor 15 in the exit side even when a predetermined time T1 lapses after the film is detected by the film detecting sensor 10 in the entrance side, whereby the microprocessor of the controlling substrate 30 judges that laminating is not normally performed, controlling the rollers 35 and 36 to rotate backward automatically.

In the meantime, according to many experiments, if the film is not detected by the film detecting sensor 15 in the exit side even when 17 second through 19 second lapses after the film is detected by the film detecting sensor 10 in the entrance side, then coating job is considered not to be normally performed. In that case, the heating roller 35 and/or the pressing roller 35 are automatically rotated backward so that the film may be drawn out to the receiving member (refer to reference numeral 5 in FIG. 1). Preferably, time for which the rollers 35 and 36 are rotated backward is about 18-19 second, which is sufficient for all the films to be removed.

For cases that laminating is not normally performed, there may exist a case that the film is wound on the rollers 35 and 36, for the heating roller 36 is not reached to the appropriate temperature depending on the thickness of the laminating film, and a case that an insertion angle of the laminating film is not correct, so that jam of the film is generated.

Also, for numbers of the heating roller 36 and the pressing roller 35 proposed in FIG. 4, two rollers constituting one party are used, but the present invention is not limited to such tow rollers, and may be applied to any case whatsoever as far as a plurality of rollers is formed in pairs, respectively. But, as far as the film detecting sensor 10 in the entrance side is provided in the front of the first roller and the film detecting sensor 15 in the exit side is provided in the back of the final roller, other elements may change to various shape whatsoever and do not matter much.

In the meantime, another embodiment of an apparatus for controlling roller rotation of the laminator according to the present invention will be described in the following.

Most of jam of the film or the case that the film is wound on the rollers 35 and 36 in the laminator are generated in the heating roller 36. Therefore, sensors are installed in the front and back of the heating roller 36 so that malfunction of the laminator may be more swiftly eliminated.

More specifically, the film detecting sensor in the entrance side and the film detecting sensor in 15 the exit side are installed in the front and the back of the heating roller, respectively, so that whether the film is wound on the heating roller 36 is detected and malfunction of the laminator is more swiftly known, whereby malfunction of the machine and disorder thereof could be prevented. Also, in case that the film detecting sensors are installed in the front and back of the heating roller 36, the waiting time after the film is detected by the film detecting sensor in the entrance side, and the time for reverse rotation of the roller for removing the film could be reduced to the half of the time.

Preferably, the waiting time since the film is detected by the sensor in the entrance side is in the range of about 8-10 second, and the time for which the heating roller 36 is rotated backward after the film is not detected by the sensor in the exit side, is in the range of about 9-10 second.

In the meantime, it is possible that the sensors are provided in the front and the back of the heating roller 36 and also provided in the front and the back of the pressing roller 35 according to a specific usage status of the product as well as the embodiment proposed above. With such construction, if the film is not detected at the back after detected by the sensor in the front of the rollers 35 and 36, it is judged that laminating is not normally performed, so that the relevant roller is rotated in order to remove the film. Namely, generation of the film jam in the specific rollers 35 and 36 is detected, whereby the film is swiftly and exactly removed.

But, upon removal of the laminating film, the rollers in the front side with respect to the roller on which the film is wound, should be all rotated backward, so that the film may be swiftly removed.

FIG. 5 is a flowchart illustrating a method for controlling roller rotation of a laminator according to the present invention.

Referring to FIG. 5, a method for controlling roller rotation of the laminator according to the present invention will be described in the following. Firstly, the power supply is applied to the laminator (step 101). If the power supply is applied, the motor and the roller are rotated forward, so that the standby step where laminating could be performed, is prepared (step 102). At the moment, the rollers 35 and 36 are always rotated so that transformation may not be generated in the rollers 35 and 36 of a circular shape while the power supply is applied and heat is applied to the rollers. Also, while the motor is rotated forward and heat is applied to the heating roller 36 so that the temperature of the heating roller (refer to reference numeral 36 in FIG. 4) is raised and heating is continuously performed, the standby indicating lamp (refer to reference numeral 2 in FIG. 1) keeps blinking so that a user may recognize that laminator is in a standby status (step 103). After the temperature of the heating roller 36 reaches an appropriate temperature (step 104), blinking of the standby indicating lamp 2 stops and a user inserts the laminating film into which material to be coated is inserted, into the receiving member (refer to reference numeral 5 in FIG. 1) (step 105). In the meantime, the step of rotating forward the roller (step 102) and the step of heating the roller (step 103) may be performed simultaneously without any priority in an order, or whether one step is performed prior to the other step does not matter much. But, if heat is applied and the rollers begin to be transformed, then the rollers 35 and 36 are rotated in order to prevent transformation generation in the rollers 35 and 36.

After the film is inserted, the film detecting sensor in the entrance side (refer to reference numeral 10 in FIG. 4) detects insertion of the laminating film, and the time from the moment that the film is detected, is counted (step 106). The film inserted into the laminator experiences heating and pressing, going through laminating process (step 107).

In the meantime, in case that laminating is not normally performed, namely, the film jam is generated or the film is wound on the rollers 35 and 36 while coating is performed in the inside of the laminator, the film is not drawn out through the drawing member (refer to reference numeral 6 in FIG. 1). Therefore, the film detecting sensor 15 in the exit side detects whether the film is present or not, determining whether laminator normally operates or not through detection results of the film detecting sensor in the exit side (step 108). More specifically, if the film is detected by the film detecting sensor 15 in the exit side after the film is detected by the film detecting sensor 10 in the entrance side and a predetermined period of time T1 lapses, then it is judged that the laminator normally operates. But, if the film is not detected by the film detecting sensor 15 in the exit side even after the film is detected by the film detecting sensor 10 in the entrance side and a predetermined period of time T1 lapses, then it is judged that the laminator does not normally operate, namely, the film is wound on the rollers 35 and 36, or the film is caught in the inside of the laminator.

If the film is detected by the film detecting sensor 15 in the exit side before a predetermined period of time T1 lapses, it is judged that the laminator normally operate and a series of laminating process could be normally completed (step 109).

On the contrary, if the film is not is detected by the film detecting sensor 15 in the exit side even after the film is detected by the film detecting sensor 10 in the entrance side and a predetermined period of time T1 lapses, then it is judged that the laminator does not normally operate and a series of step for removing film begins.

In the meantime, the predetermined period of waiting time T1 before the film is detected by the film detecting sensor in the exit side after the film is inserted to the side of the film detecting sensor 10 in the entrance side, is preferably in the range of 14-16 second. But, the waiting time T1 may change depending on a number of rollers provided and rotational speed of the motor, and the above waiting time T1 is preferably well applied to the case that the heating roller 36 and the pressing roller 35 are provided in one pair, respectively.

Also, in case that the film is not detected by the film detecting sensor 15 in the exit side at the step of detecting the film (step 108) and it is judged that the laminator does not normally operate, the roller is rotated backward for a predetermined period of time T2 so that the film is removed from the inside of the laminator (step 110). For a method for rotating backward the roller, a method for rotating backward the dual-direction rotating motor is possibly used, and a variety of methods for mechanically reversing rotational direction using device may be adopted for a case of one direction rotating motor.

In the meantime, the time T2 for which the motor is rotated backward is preferably in the range of 18-20 second. The time T2 for reverse rotation of the motor is sufficient for removing the laminating film in the jam status in the inside of the laminator or wound on the roller, and could change depending on rotational speed of the motor and a number of rollers. Here, the time T2 for reverse rotation of the motor may be well preferably used for the case that a pair of heating rollers 36 and a pair of pressing rollers 35 are adopted.

If the film is completely removed at the step of rotating backward the motor (step 110), the roller is rotated forward again so that new laminating may be swiftly performed (step 111).

The reason why the heating roller 36 and the pressing roller 35 are not stopped during laminating job as described above, is for transformation not to be generated to the rollers 35 and 36 by heat generated from the inside of the laminator when the rollers 35 and 36 are stopped.

In case that the rollers are rotated forward, the step of inserting the film (step 105) where new laminating film is inserted, is performed so that the laminating job may be possibly performed again.

In case that the film detecting sensor 10 and 15 are provided in the front and the back of the heating roller 36, detection of abnormal operation of the laminator and removal of the film could be more swiftly accomplished.

The second embodiment of the method for controlling roller rotation of the laminator will be described in the following.

The second embodiment of the method for controlling roller rotation of the laminator are the same as the first embodiment except difference in the procedure by which the film is removed from the inside of the laminator. The step of removing the laminating film will be described in detail in the following.

A user could forcibly pull the film through the receiving member (refer to reference numeral 5 in FIG. 1) during reverse rotation of the motor in the step of removing the laminating film (step 110 in FIG. 5). In that case, the film could be more swiftly and easily removed than the case that the film is removed by reverse rotation of the motor. If the film is forcibly removed through the receiving member (refer to reference numeral 5 in FIG. 1) by external force of a user, then the film is not detected by the film detecting sensor 10 in the entrance side. Therefore, at the moment, the controlling substrate (refer to reference numeral 30 in FIG. 3) judges that the laminating film is completely removed from the receiving member 5, so that the rollers 35 and 36 are rotated forward again even before a predetermined period of time T2 lapses.

The foregoing second embodiment of the method for controlling roller rotation of the laminator could remove the film that is not normally laminated more swiftly and reliably, thereby improving speed of the laminating process.

In the meantime, if the film is seriously wound on the roller, or is not easily removed from the inside of the laminator, the rollers 35 and 36 are continuously set to the position for reverse rotation by the power switch, whereby removal of the film could be reliably performed.

And, if the film is not removed in laminator during the determined interval, it may be possible to switch off the operation of the roller and to switch off the heating of the heating roller, preventing the film from melted adhesively in the laminator.

### INDUSTRIAL APPLICABILITY

According to the apparatus and method for controlling roller rotation of the laminator of the present invention, the position of the film could be detected in the inside of the laminator, so that whether the laminator normally operates or not could be swiftly known.

Also, a user could find out exactly and reliably the position of the film by electronically detecting method, not by feeling of a user, thereby preventing destruction of the laminator machine itself due to winding of the film on the roller for a long time.

Also, thanks to the construction that the sensors are provided in the front and the back of the roller with respect to the progressing direction of the laminating film, whether the film is wound on the roller or not is detected, whereby reliable operation of the product could be guaranteed.

While the invention has been shown and described with reference to certain preferred embodiments thereof, it will be understood by those skilled in the art that various changes in form and details may be made therein without departing from the spirit and scope of the invention as defined by the appended claims.

1. An apparatus for controlling roller rotation of a laminator comprising:
rollers installed in even numbers, for applying heat and pressure in order to perform coating using a laminating film;
a film detecting sensor in an entrance side, formed in a front side or at least one of said rollers with respect to the progressing direction of a laminating film, for detecting whether the laminating film is inserted or not;
a film detecting sensor in an exit side, formed in a rear side of at least one of said rollers for detecting whether the laminating film is drawn out or not;
a dual-direction rotating motor for rotating the roller forward or backward depending on a detecting signal from the film detecting sensors in the entrance side and the exit side;
a microprocessor for receiving a detecting signal from either or both of said sensors and transmitting a controlling signal to the dual-direction rotating motor; and
a power transferring unit for transferring power from the dual-direction motor to the rollers.

2. The apparatus according to claim 1, wherein the rollers are comprise a heating roller and a pressing roller.

3. The apparatus according to claim 1, wherein the film detecting sensor in the entrance side and/or the film detecting sensor in the exit side are/is an ultraviolet sensor whose light emitting unit and the light receiving unit are provided in one pair, for checking whether the laminating film is present or not by detecting light reflected from the laminating film.

4. The apparatus according to claim, further comprising:
a temperature adjusting member formed on an outer periphery of the laminator, for setting an appropriate temperature depending on each laminating film;
a heat applying unit formed on an outer periphery, spaced from at least one roller, for applying heat on at least one roller according to designation by the temperature adjusting member; and
a temperature sensor formed on an outer periphery of at least one roller, for checking whether the roller reaches an appropriate temperature.

5. A method for controlling roller rotation of a laminator comprising the steps of:
counting time from the moment that insertion of a laminating film is detected by a film detecting sensor in an entrance side after the laminating film is inserted into the laminator;
detecting, at a film detecting sensor in an exit side, the laminating film after a waiting time T1 that is necessary for normal laminating operation lapses; and
if the laminating film is detected before the waiting time T1 lapses, judging that normal laminating is performed, and, if the laminating film is not detected even after the waiting time T1 lapses, removing the film by rotating backward the roller for a predetermined period of time T2 for reversion rotation under judgement that normal laminating is not preformed.

6. The method according to claim 5, wherein the waiting time T1 is within range of 14-16 second.

7. The method according to claim 5, wherein the time T2 for reversion rotation is within a range of 18-20 second.

8. The method according to claim 5, wherein the rollers are automatically rotated forward after the rollers are rotated backward for the time T2 for reverse rotation of the motor.

9. The method according to claim 5, wherein in case that the film detecting sensor in the exit side and the film detecting sensor in the entrance side are provided in a front and a back of the heating roller, respectively, the waiting time T1 before the film is detected by the film detecting sensor in the exit side after the film is detected by the film detecting sensor in the entrance side, is within a range of 8-10 second.

10. The method according to claim 5, wherein in case that the film detecting sensor in the exit side and the film detecting sensor in the entrance side are provided in a front and a back of the heating roller, the T2 for which the heating roller is rotating backward because the film is not detecting by the film detecting sensor in the exit side, is within a range of 9-10 second.

11. A method for controlling roller rotation of a laminator comprising the steps of:
counting time from the moment that insertion of a laminating film is detected by a film detecting sensor in an entrance side after the laminating film is inserted into the laminator;
detecting, at a film detecting sensor in an exit side, the laminating film after a waiting time T1 that is necessary for normal laminating operation lapses;
if the laminating film is detecting before the waiting time T1 lapses, rotating forward the rollers under judgment that normal laminating is performed, and if the laminating film is not detected even after the waiting time T1 lapses, removing the film by applying external force and rotating backward under judgment that normal laminating is not performed, and
if the laminating film is not detected by the film detecting sensor in the entrance side, rotating forward the rollers under judgement that the laminating film is completely removed.

12. The method according to claim 11, wherein the waiting time T1 is within a range of 14-16 second.

13. The method according to claim 11, wherein the rotation of the roller and/or heating of the heating roller is switched off, when the film is not removed in laminator.

14. An apparatus for controlling roller rotation of a laminator comprising:
at least one pair of rollers installed in even numbers, for applying heat and/or pressure in order to perform coating using a laminating film;
a film detecting sensor in an entrance side, formed in a front side of a first roller with respect to the progressing direction of the laminating film, for detecting whether the laminating film is inserted or not;
a film detecting sensor in an exit side, formed in a rear side of a final roller, for detecting whether the laminating film is drawn out or not;
a microprocessor for detecting a position of the laminating film by a detecting signal from at least one of the sensors; and
a motor and a power transferring unit for rotating forward or backward the roller under control of the microprocessor.

15. An apparatus for controlling roller rotation of a laminator comprising:
a heating roller installed in even numbers, for applying heat in order to perform coating using a laminating film;
a film detecting sensor in an entrance side, formed in a front side of the heating roller with respect to the progressing direction of the laminating film, for detecting whether the laminating film is inserted or not;
a film detecting sensor in an exit side, formed in a rear side of the heating roller, for detecting whether the laminating film is drawn out or not;
a microprocessor for receiving a detecting signal from either or both of the sensors and transmitting a controlling signal of the heating roller using the detecting signal;
a dual-direction rotating motor for rotating the roller backward if the laminator does not normally operate depending in a controlling signal from the microprocessor, and
a power transferring unit for transferring unit for transferring power from the dual-direction motor to the roller.
